(19) United States
(12) Patent Application Publication
(10) Pub. No.: US 2022/0198600 A1
(43) Pub. Date: Jun. 23, 2022

(54) INFORMATION PROCESSING APPARATUS, INFORMATION PROCESSING METHOD, AND SYSTEM

(71) Applicant: TOYOTA JIDOSHA KABUSHIKI KAISHA, Toyota-shi (JP)

(72) Inventor: Hideo HASEGAWA, Nagoya-shi (JP)

(73) Assignee: TOYOTA JIDOSHA KABUSHIKI KAISHA, Toyota-shi (JP)

(21) Appl. No.: 17/519,923

(22) Filed: Nov. 5, 2021

(30) Foreign Application Priority Data
Dec. 17, 2020 (JP) 2020-208899

(51) Int. Cl. G06Q 50/30; G06Q 10/06

(52) U.S. Cl. CPC G06Q 50/30; G06Q 10/06315

(57) ABSTRACT

An information processing apparatus includes a controller configured to perform: detecting a combination of actions of a user before the user moves; allowing the user to select a first combination of actions related to a movement of the user from among the combinations of actions detected; and providing a service to the user when the first combination of actions is detected.

### CROSS REFERENCE TO THE RELATED APPLICATION

This application claims the benefit of Japanese Patent Application No. 2020-208899, filed on Dec. 17, 2020, which is hereby incorporated by reference herein in its entirety.

### BACKGROUND

### Technical Field

The present invention relates to an information processing apparatus, an information processing method, and a system.

### Description of the Related Art

There has been known a technique of dispatching a vehicle in response to a request of a user (for example, see Patent Literature 1).

### CITATION LIST

### Patent Literature

Patent Literature 1: Japanese Patent Application Laid-Open Publication No. 2002-063690

### SUMMARY

When there is a sign that a user is about to move, it is conceivable to dispatch a vehicle to the user without directly receiving a request from the user. However, if the sign of movement is not accurately detected, a vehicle may not be dispatched when it is needed, or may be dispatched when it is not needed. An object of the present invention is to provide a service when it is necessary for a user.

One aspect of the present disclosure is directed to an information processing apparatus including a controller configured to perform:

detecting combinations of actions of a user before the user moves;

allowing the user to select a first combination of actions related to a movement of the user from among the combinations of actions detected; and providing a service to the user when the first combination of actions is detected.

Another aspect of the present disclosure is directed to an information processing method for causing a computer to perform:

detecting combinations of actions of a user before the user moves;

allowing the user to select a first combination of actions related to a movement of the user from among the combinations of actions detected; and providing a service to the user when the first combination of actions is detected.

A further aspect of the present disclosure is directed to a system comprising:

a sensor configured to detect actions of a user;

a terminal of the user; and

a server having a controller;

wherein the controller performs:

detecting, based on the actions of the user detected by the sensor, combinations of actions of the user before the user moves;

transmitting, to the terminal of the user, information for allowing the user to select a first combination of actions related to a movement of the user from among the combinations of actions detected;

receiving information about the first combination of actions from the terminal of the user; and

providing a service to the user when the first combination of actions is detected.

In addition, a still further aspect of the present disclosure is directed to a program for causing a computer to perform the above-described information processing method, or a non-transitory storage medium storing the program.

According to the present disclosure, a service can be provided when it is necessary for a user.

### BRIEF DESCRIPTION OF THE DRAWINGS

FIG. 1 is a view illustrating a schematic configuration of a vehicle dispatch system according to an embodiment;

FIG. 2 is a block diagram schematically illustrating an example of a configuration of each of a sensor, a user terminal and a server, which together constitute the system according to the embodiment;

FIG. 3 is a diagram illustrating an example of a functional configuration of the server;

FIG. 4 is a view illustrating a table configuration of action information stored in an action information DB;

FIG. 5 is a view illustrating an image displayed on an output unit of the user terminal when an inquiry about association between a combination of actions of a user and a sign of movement thereof is transmitted from the server to the user terminal;

FIG. 6 is a view illustrating an image related to a response received from the user terminal;

FIG. 7 is a view illustrating an example of a table configuration of the action information after each field has been adjusted based on the response from the user terminal;

FIG. 8 is a flowchart of vehicle dispatch processing in the server; and

FIG. 9 is a flowchart of confirmation processing.

### DESCRIPTION OF THE EMBODIMENTS

An information processing apparatus according to an embodiment includes a controller. This controller performs: detecting combinations of actions of a user before the user moves; allowing the user to select a first combination of actions related to a movement of the user from among the combinations of actions detected; and providing a service to the user when the first combination of actions is detected.

The controller provides a service to the user when the user performs a movement. The movement in this case includes the user going out from home. Here, note that, in addition to going out from home, a movement from a building other than home such as a commercial facility or an office building may be included. Also, the service includes the provision of transportation. For example, a vehicle may be arranged when the user moves. The vehicle may be, for example, a manned taxi, an unmanned taxi, a manned rideshare vehicle, or an unmanned rideshare vehicle. A vehicle capable of autonomous traveling can be used as an unmanned taxi or an unmanned rideshare vehicle. As an alternative, for example, a rental bicycle may be arranged for the user.

The controller detects combinations of actions of the user before the user moves. These combinations of actions may be, for example, combinations of actions detected up to a predetermined time before a time point at which the user moved. The actions of the user before the user moves include actions related to the user's movement. Therefore, the combinations of actions of the user detected before the user's movement are considered to include a combination of actions related to a sign of the movement of the user. However, there is a possibility that actions unrelated to the sign of the user's movement may be included. It is also possible to exclude actions that are unrelated to such a sign of the user's movement, for example, by learning. However, it takes time to learn.

Therefore, the controller allows the user to select a first combination of actions related to the movement of the user from among the combinations of actions detected. In other words, the time required for learning can be shortened by allowing the user to select the first combination of actions that is related to the user's movement. In addition, by allowing the user to select the first combination of actions by himself or herself, it is possible to grasp a combination of actions that is highly related to a sign of the user's movement.

Then, when the first combination of actions is subsequently detected, the controller provides a service to the user, whereby the service can be provided when it is necessary for the user.

Here, note that in the following embodiments, a service of arranging for a taxi capable of autonomous traveling to be sent to a user's home will be described, but the present invention is not limited to this, and for example, it can also be used for a service that delivers a bicycle or the like to a user's home when it is rented out to a user.

Hereinafter, embodiments of the present disclosure will be described based on the accompanying drawings. The configurations of the following embodiments are examples, and the present disclosure is not limited to the configurations of the embodiments.

### First Embodiment

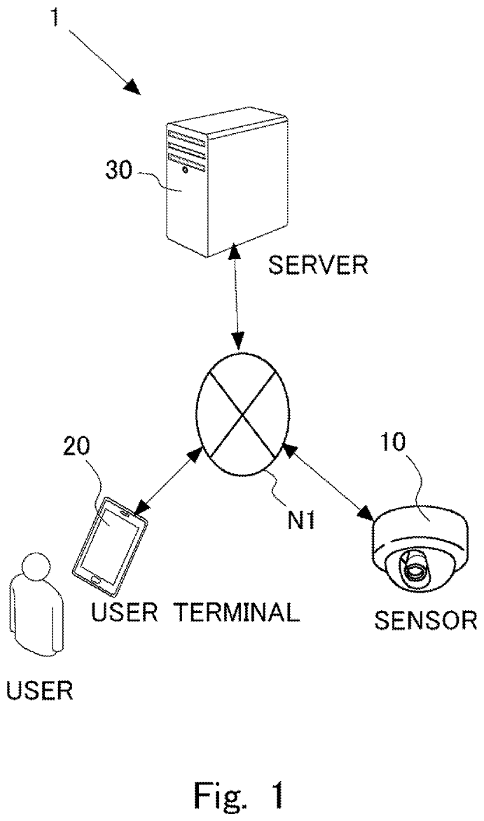

FIG. 1 is a view illustrating a schematic configuration of a vehicle dispatch system 1 according to a first embodiment. The vehicle dispatch system 1 includes, for example, a sensor 10, a user terminal 20, and a server 30. The server 30 is an example of an information processing apparatus. A user in FIG. 1 is a user who operates the user terminal 20 and also uses a vehicle (e.g., a taxi) that is arranged by the vehicle dispatch system 1. Here, note that the vehicle is, for example, an autonomous driving vehicle. The user can request the server 30 to dispatch a vehicle via the user terminal 20. There can be more than one user, and depending on the number of users, there can be more than one user terminal 20. The sensor 10 detects an action(s) or behavior(s) of the user. There can be a plurality of sensors 10. The actions of the user detected by the sensor(s) 10 are transmitted to the server 30.

The vehicle dispatch system 1 illustrated in FIG. 1 is, for example, a system in which the vehicle is dispatched to the user according to information inputted or entered into the user terminal 20 by the user or a detection result of the sensor 10. That is, when the user enters information for requesting the dispatch of a vehicle to the user terminal 20, the information is transmitted to the server 30, so that the server 30, which has received the information, performs vehicle dispatch. In addition, based on the action(s) detected by the sensor 10, a sign of the user going out or a sign of the user moving by the vehicle can be detected. Note that in the following, these signs are also referred to as signs of movement. When there is such a sign of movement, the server 30 performs vehicle dispatch. The server 30 has stored (or learned) actions before the user goes out or before the user requests vehicle dispatch. Then, when the same actions are thereafter detected by the sensor 10, it is determined that there is a sign of movement. Thus, when there is a sign of movement, the server 30 dispatches a vehicle before the user goes out.

The sensor 10, the user terminal 20, and the server 30 are connected to each other by means of a network N1. The network N1 is, for example, a worldwide public communication network such as the Internet or the like, and a WAN (Wide Area Network) or other communication networks may be adopted. Also, the network N1 may include a telephone communication network such as a mobile phone network or the like, and/or a wireless communication network such as Wi-Fi (registered trademark) or the like.

### (Hardware Configuration)

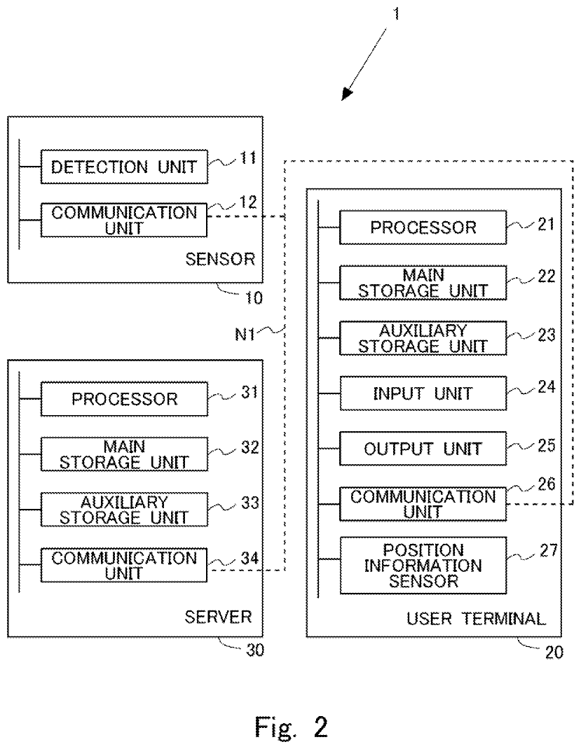

Hardware configurations of the sensor 10, the user terminal 20, and the server 30 will be described based on FIG. 2. FIG. 2 is a block diagram schematically illustrating an example of a configuration of each of the sensor 10, the user terminal 20 and the server 30, which together constitute the vehicle dispatch system 1 according to the present embodiment.

The server 30 has a configuration of a general computer. The server 30 includes a processor 31, a main storage unit 32, an auxiliary storage unit 33, and a communication unit 34. These components are connected to one another by means of a bus. Note that the processor 31 is an example of a controller. Also, the main storage unit 32 and the auxiliary storage unit 33 are examples of a memory.

The processor 31 is a CPU (Central Processing Unit), a DSP (Digital Signal Processor), or the like. The processor 31 controls the server 30 thereby to perform various information processing operations. The main storage unit 32 is a RAM (Random Access Memory), a ROM (Read Only Memory), or the like. The auxiliary storage unit 33 is an EPROM (Erasable Programmable ROM), a hard disk drive (HDD), a removable medium, or the like. Also, the auxiliary storage unit 33 stores an operating system (OS), various programs, various tables, and the like. The processor 31 loads a program stored in the auxiliary storage unit 33 into a work area of the main storage unit 32 and executes the program, so that each component or the like is controlled through the execution of the program. As a result, the server 30 realizes functions that match predetermined purposes. The main storage unit 32 and the auxiliary storage unit 33 are computer readable recording media. Here, note that the server 30 may be a single computer or a plurality of computers that cooperate with one another. In addition, the information stored in the auxiliary storage unit 33 may be stored in the main storage unit 32. Also, the information stored in the main storage unit 32 may be stored in the auxiliary storage unit 33.

The communication unit 34 is a means or unit that communicates with the sensor 10 and user terminal 20 via network N1. The communication unit 34 is, for example, a LAN (Local Area Network) interface board, a wireless communication circuit for wireless communication, or the like. The LAN interface board or the wireless communication circuit is connected to the network N1.

Here, note that a series of processing executed by the sever 30 can be executed by hardware, but can also be executed by software. The hardware configuration of the server 30 is not limited to the one illustrated in FIG. 2.

Now, the user terminal 20 will be described. The user terminal 20 is a smart phone, a mobile phone, a tablet terminal, a personal information terminal, a wearable computer (such as a smart watch or the like), or a small computer such as a personal computer (PC). The user terminal 20 includes a processor 21, a main storage unit 22, an auxiliary storage unit 23, an input unit 24, an output unit 25, a communication unit 26, and a position information sensor 27. These components are connected to one another by means of a bus. The processor 21, the main storage unit 22, and the auxiliary storage unit 23 of the user terminal 20 are the same as the processor 31, the main storage unit 32, and the auxiliary storage unit 33 of the server 30, respectively, and hence, the description thereof will be omitted.

The input unit 24 is a means or unit that receives an input operation performed by a user, and is, for example, a touch panel, a push button, a mouse, a keyboard, a microphone, or the like. The output unit 25 is a means or unit that serves to present information to the user, and is, for example, an LCD (Liquid Crystal Display), an EL (Electroluminescence) panel, a speaker, a lamp, or the like. The input unit 24 and the output unit 25 may be configured as a single touch panel display.

The communication unit 26 is a communication means or unit for connecting the user terminal 20 to the network N1. The communication unit 26 is, for example, a circuit for communicating with other devices (e.g., the server 30 and the like) via the network N1 by making use of a mobile communication service (e.g., a telephone communication network such as 5G (5th Generation), 4G (4th Generation), 3G (3rd Generation), or LTE (Long Term Evolution)) or a wireless communication network such as Wi-Fi (registered trademark) or the like.

The position information sensor 27 obtains position information (e.g., latitude and longitude) of the user terminal 20 at predetermined intervals. The position information sensor 27 is, for example, a GPS (Global Positioning System) receiver unit, a wireless communication unit or the like. The information obtained by the position information sensor 27 is recorded, for example, in the auxiliary storage unit 23 or the like, and transmitted to the server 30.

Next, the sensor 10 will be described. The sensor 10 includes a detection unit 11 that detects an action(s) of a user and a communication unit 12 that transmits a detection result of the detection unit 11 to the server 30. The detection unit 11 detects changes in the state of the user, furniture, home appliances, room, house, or the like due to actions of the user. The detection unit 11 may take pictures by using an imaging element such as a CCD (Charge Coupled Device) image sensor, a CMOS (Complementary Metal Oxide Semiconductor) image sensor or the like. The pictures obtained by photographing may be either still images or moving images. The sensor 10 may simply transmit the pictures or images obtained by the photographing to the server 30, so that the action(s) of the user may be identified by analyzing the images at the server 30. In addition, the detection unit 11 may, for example, detect the ON-OFF of a switch of a home appliance. Further, the detection unit 11 may, for example, detect the opening and/or closing of a room door or a closet door.

In addition, the detection unit 11 may detect, for example, that the user has brushed his or her teeth. For example, it may detect that the user has brushed his or her teeth when the power of an electric toothbrush is turned on, or when the action of the user brushing his or her teeth is captured by a camera. Also, for example, the detection unit 11 may detect that the user turns off the power of a television. For example, it may be detected by a sensor that the power of the television is turned off, or it may be detected that an instruction to turn off the power of the television is inputted to a smart speaker by voice. Moreover, the detection unit 11 may detect, for example, that the power of a personal computer (PC) is turned off, by means of a sensor. Further, the detection unit 11 may detect that the user has smoked a cigarette. For example, it may detect that the user has smoked a cigarette, when an action of the user smoking a cigarette is captured by a camera, or when a rise in the temperature of a lighter is detected, or when the operation of an air purifier is an operation corresponding to smoking. Furthermore, the detection unit 11 may detect that the user has used a toilet when the door of the toilet is opened and/or closed, and may detect that the user has used a bath when the door of the bath is opened and/or closed. If all the actions of the user are to be detected, the number of actions to be detected become enormous, and hence, the actions to be detected by the sensor 10 may have been determined in advance.

The communication unit 12 is a communication means or unit for connecting the sensor 10 to the network N1. The communication unit 12 is, for example, a circuit for communicating with other devices (e.g., the server 30 or the like) via the network N1 by making use of a mobile communication service (e.g., a telephone communication network such as 5G (5th Generation), 4G (4th Generation), 3G (3rd Generation), LTE (Long Term Evolution) or the like), or a wireless communication such as Wi-Fi (registered trademark), Bluetooth (registered trademark) or the like. The detection result of the sensor 10 is sequentially transmitted to the server 30 via the communication unit 12.

### (Functional Configuration: Server)

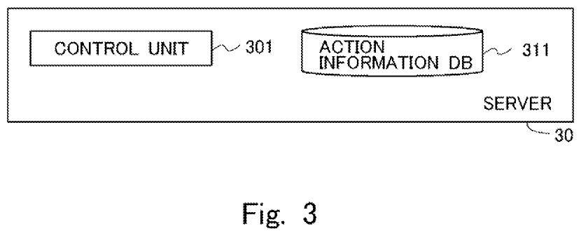

Now, the functions of the server 30 will be described. FIG. 3 is a diagram illustrating an example of a functional configuration of the server 30. The server 30 includes a control unit 301 and an action information DB 311 as functional components. The processor 31 of the server 30 executes the processing of the control unit 301 by a computer program on the main storage unit 32. However, the control unit 301 or a part of the processing thereof may be executed by a hardware circuit.

The action information DB 311 is built by a program of a database management system (DBMS) that is executed by the processor 31 to manage data stored in the auxiliary storage unit 33. The action information DB 311 is, for example, a relational database.

Here, note that any of the individual functional components of the server 30 or a part of the processing thereof may be executed by another or other computers connected to the network N1.

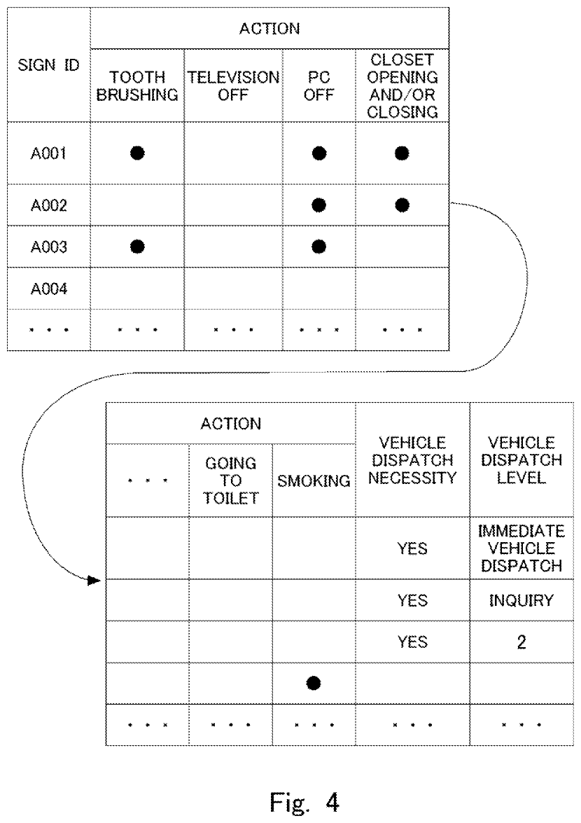

FIG. 4 is a diagram illustrating a table configuration of action information stored in the action information DB 311. The action information table includes respective fields of sign ID, action, necessity of dispatch, and level of dispatch. In the sign ID field, identification information (sign ID) for identifying a combination of actions of a user before going out is entered. In the action field, a combination of actions of a user before going out is stored. Specifically, in the action field, for example, all the actions, which are actions performed by the user up to a predetermined time before a time point at which the user went out and which have been detected by the sensor 10, are entered. For example, in the case where the sign ID is A001, it indicates that the user brushes his or her teeth, turns off the power of a personal computer (PC), and opens and/or closes a closet before going out. The actions to be entered in the action field may have been determined in advance.

In the vehicle dispatch necessity field, the result of learning as to whether or not a user needs the dispatch of a vehicle is entered. Note that when a user goes out, it is assumed that the user needs the dispatch of a vehicle. For example, a combination of actions before a user goes out is stored, and when the same combination of actions is detected before the user goes out, the number of times the combination of actions is detected is counted. Then, when the number of times of detection becomes equal to or greater than a predetermined number of times (e.g., three times), the combination of actions is treated as being related to a sign of movement of the user. In this case, “YES” is entered in the vehicle dispatch field. In this way, the combination of actions and the sign of movement of the user are associated with each other. Thus, when the same combination of actions is detected the predetermined number of times, it is learned that there is an association between the combination of actions and the sign of movement.

In the vehicle dispatch level field, information about the operation of the server 30 when dispatching a vehicle is entered. For example, “immediate dispatch” means that a vehicle is dispatched immediately when a corresponding combination of actions is detected. In addition, for example, “inquiry” means to inquire of the user whether or not to perform vehicle dispatch when a corresponding combination of actions is detected. Also, the number of times the same combination of actions is detected may be entered in the vehicle dispatch level field. For example, in cases where the same combination of actions is detected three times or more as actions before going out, “immediate dispatch” may be set to be entered into the vehicle dispatch level field, and the number of times the same combination of actions is detected may be entered until “immediate dispatch” is entered. In cases where the vehicle dispatch level field is blank, it means that vehicle dispatch is not performed.

The control unit 301 sequentially stores the actions of the user received from the sensor 10 in the auxiliary storage unit 33. Then, when there is a request for vehicle dispatch from the user terminal 20, the control unit 301 extracts all actions of the user up to a predetermined time before the time of the request and stores the actions in the action information DB 311. In addition, in cases where the same combination of actions has already been stored, the number of times the same combination of actions is detected may be counted up and entered. Further, when the number of times is equal to or greater than the predetermined number of times, “immediate dispatch” may be entered into the vehicle dispatch level field.

As described above, by storing the combination of actions before the user goes out, it is possible to predict that the user will go out when the same combination of actions is detected in the future. Then, if the server 30 dispatches a vehicle when the user is expected to go out, it is possible to perform vehicle dispatch at an appropriate time without the user requesting vehicle dispatch by himself or herself.

However, it takes time to associate a combination of actions of the user with a sign of movement of the user. For example, there are actions of the user before going out that are unrelated to going out. It is difficult to determine based on a single going out whether or not actions of the user are related to going out. Therefore, in order to associate an action(s) of the user with going out, it is necessary for the user to go out a plurality of times after performing the action(s). The more times this is done, the more accurate the prediction of the user's going out becomes, but it also takes more time.

In addition, for example, in cases where the association between a combination of actions of the user and a sign of movement is wrong, the server 30 may not be able to recognize this mistake. For example, in cases where the server 30 dispatches a vehicle even though the user does not plan to go out, there may be a case where the user gets on the vehicle because the vehicle has arrived. In this case, the server 30 cannot recognize that the vehicle has been erroneously dispatched. If a vehicle is dispatched without the need of vehicle dispatch in this way, when the number of vehicles is limited, there is a possibility that vehicles will not be dispatched to other users who need them, in cases where the number of vehicles is limited.

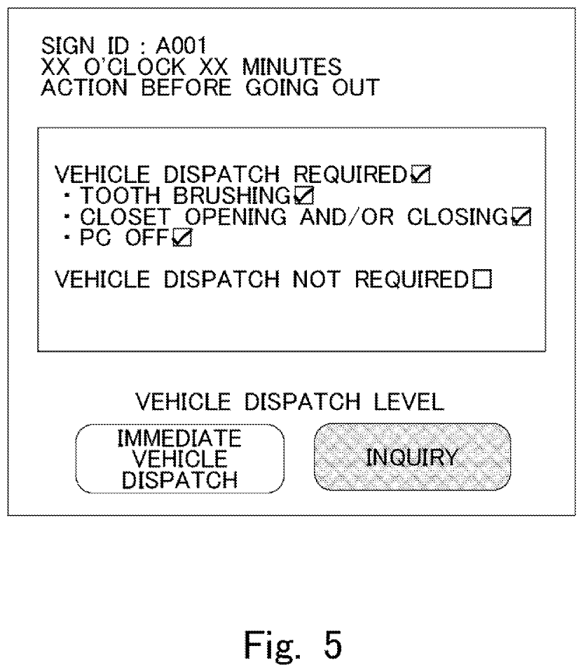

Therefore, the control unit 301 transmits, to the user terminal 20, an inquiry about the association between a combination of actions of the user and a sign of movement thereof. FIG. 5 is a view illustrating an image displayed on the output unit 25 of the user terminal 20 when an inquiry about the association between a combination of actions of the user and a sign of movement thereof is transmitted from the server 30 to the user terminal 20. FIG. 5 illustrates an example of the inquiry to be transmitted to the user terminal 20 when a combination of actions corresponding to the A001 of the sign ID in FIG. 4 is extracted. The example illustrated in FIG. 5 indicates that the user has brushed his or her teeth, has opened and/or closed the closet, and has turned off his or her personal computer (PC). At this time, a check is entered in a check box corresponding to each of these actions. This action for which a check is entered in the check box indicates that the action is related to the user's going out.

Further, in the example illustrated in FIG. 5, a check is entered in a check box corresponding to “vehicle dispatch required “. The check box corresponding to “vehicle dispatch required” is a check box indicating that vehicle dispatch is required. On the other hand, a check box corresponding to “vehicle dispatch not required” is a check box indicating that vehicle dispatch is not required. Only one of the check boxes of “vehicle dispatch required” and “vehicle dispatch not required” can be checked, and can be selected by the user. In an initial state in which an inquiry is transmitted from the server 30 to the user terminal 20, a check is entered in the check box corresponding to “vehicle dispatch required”. The “vehicle dispatch level” in FIG. 5 corresponds to the vehicle dispatch level in FIG. 4. Therefore, “immediate dispatch” is selected as the vehicle dispatch level.

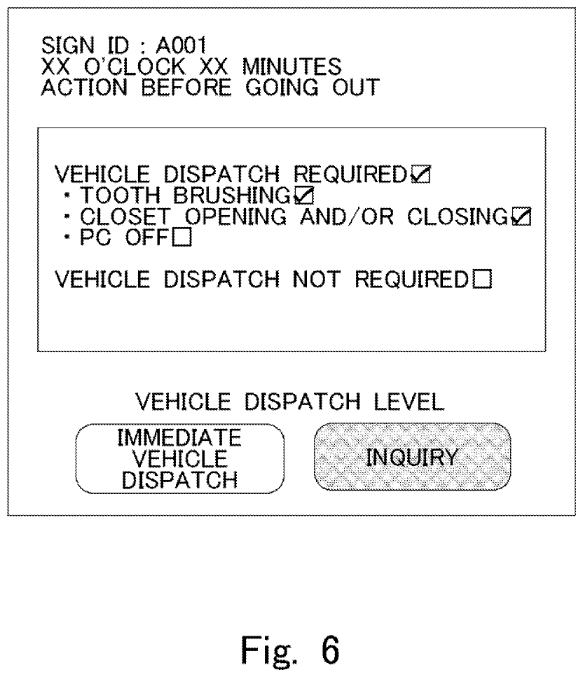

When the inquiry illustrated in FIG. 5 is transmitted to the user terminal 20, the user enters a response in the user terminal 20 so that the response is transmitted to the server 30. FIG. 6 is a view illustrating an image related to the response received from the user terminal 20. The user has unchecked a check box corresponding to “PC OFF”. That is, the user has responded that turning off the power of the personal computer is unrelated to user's going out. In this case, brushing user's teeth and opening and/or closing the door of the closet are selected as a combination of actions related to user's going out. Therefore, when this combination of actions is detected, the action information DB 311 is updated so that the control unit 301 performs vehicle dispatch. The combination of actions selected in FIG. 6 is an example of a first combination of actions.

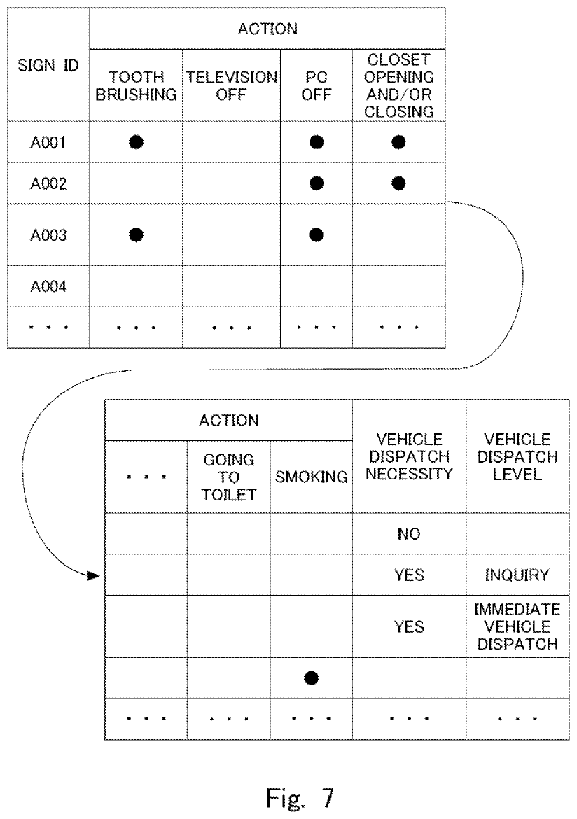

FIG. 7 is a diagram illustrating a table configuration of action information after each field is adjusted based on the response from the user terminal 20. In cases where the check box of “PC OFF” is unchecked by the user, the combination of actions related to the A001 of the sign ID is unrelated to going out of the user, and hence “NO” indicating that vehicle dispatch is not required or necessary is entered in the vehicle dispatch necessity field. On the other hand, since the user has not removed the check in the check box corresponding to “vehicle dispatch required”, the combination of “tooth brushing” and “closet opening and/or closing” is considered to be related to the user's going out, so that vehicle dispatch is to be performed by this combination of actions. That is, A003 of the sign ID is a combination of actions corresponding to the response of the user, and hence “immediate dispatch” is entered into the vehicle dispatch level field for the A003 of the sign ID. Therefore, when the combination of “tooth brushing” and “closet opening and/or closing” is detected, vehicle dispatch is performed according to the A003 of the sign ID, regardless of whether or not “PC OFF” is detected.

Here, note that the user can also change the vehicle dispatch level. For example, when the user selects “inquiry” of the vehicle dispatch level, “inquiry” is entered into the vehicle dispatch level field of the A003 of the sign ID. Further, in cases where the user does not remove the check box of “PC OFF” and selects “vehicle dispatch not required”, “NO” is entered into the vehicle dispatch necessity field of the A001 of the sign ID.

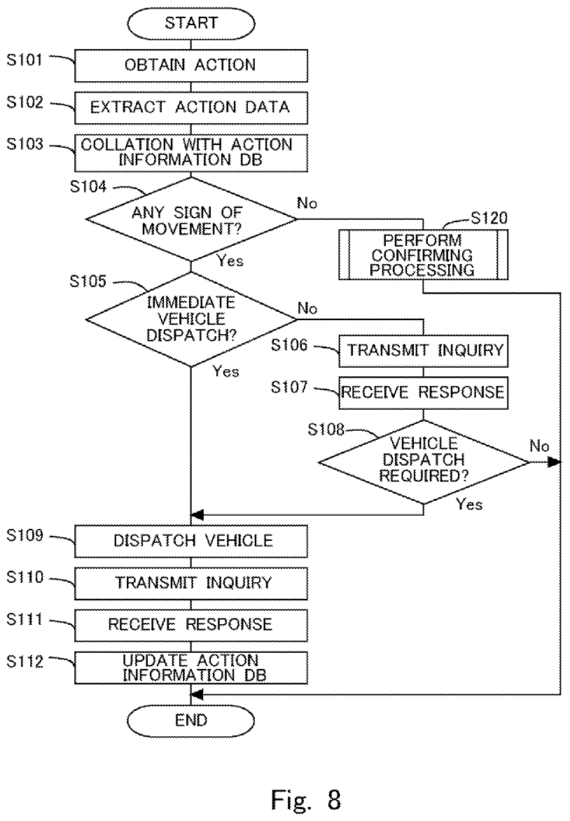

Next, specific contents of the processing performed in the server 30 will be described. FIG. 8 is a flowchart of vehicle dispatch processing in the server 30. A routine illustrated in FIG. 8 is executed at predetermined time intervals in the server 30. The routine illustrated in FIG. 8 is executed for each user.

In step S101, the control unit 301 receives actions of the user from the sensor 10. The actions of the user are stored in the auxiliary storage unit 33 in association with their time points. In step S102, the control unit 301 extracts action data. The action data is data including all actions of the user detected before a predetermined time from a current time point, and is also data indicating a combination of actions. The predetermined time has been set in advance as a period of time during which the user performs actions correlated with the user going out. The predetermined time may be set by the user or may be set by the control unit 301. In addition, the predetermined time may be obtained by machine learning so as to further increase the relationship (or association) between a sign of movement and a combination of actions.

In step S103, the control unit 301 matches the action data against the action information DB 311 and extracts a matching record. That is, it is matched whether or not the combination of actions extracted in step S102 is already stored in the action information DB 311. In step S104, the control unit 301 determines whether or not there is a sign of movement.

Specifically, the control unit 301 determines, based on the matching result in step S103, whether or not there is a sign of movement of the user. That is, in cases where there is a record in the action information DB 311 that matches the combination of actions, and in cases where “YES” is entered in the vehicle dispatch necessity field of the record and “immediate dispatch” or “inquiry” is entered in the vehicle dispatch level field, it is determined that there is a sign of movement. Otherwise, it is determined that there is no sign of movement. In cases where “YES” is entered in the vehicle dispatch necessity field and “immediate dispatch” or “inquiry” is entered in the vehicle dispatch level field, the user has performed the same actions before going out in the past. Therefore, when the same combination of actions is detected, it can be considered that there is a sign of movement. When an affirmative determination is made in step S104, the processing proceeds to step S105, whereas when a negative determination is made, the processing proceeds to step S120.

In step S105, the control unit 301 determines whether or not “immediate dispatch” has been entered in the vehicle dispatch level field of the record corresponding to the action date. In this step S105, it is determined which of “immediate dispatch” and “inquiry” is entered in the vehicle dispatch level field. When an affirmative determination is made in step S105, the processing proceeds to step S109, whereas when a negative determination is made, the processing proceeds to step S106.

In step S106, the control unit 301 transmits an inquiry to the user terminal 20 as to whether or not to dispatch a vehicle. That is, since “inquiry” is entered in the vehicle dispatch level field, the user is inquired whether or not vehicle dispatch is required. In response to this inquiry, the user responds whether or not vehicle dispatch is required. The control unit 301 displays an inquiry as to whether or not to dispatch a vehicle on the output unit 25 of the user terminal 20, generates a command to prompt the user to respond, and transmits the command to the user terminal 20. In step S107, the control unit 301 receives a response from the user terminal 20. Here, note that in cases where no response is received from the user terminal 20 even after waiting for a predetermined period of time, it may be treated as if a response to the effect that vehicle dispatch is not required is received.

In step S108, the control unit 301 determines whether or not it is necessary to perform vehicle dispatch. The control unit 301 makes a determination according to the response received from the user terminal 20 in step S107. When an affirmative determination is made in step S108, the processing or routine proceeds to step S109, whereas when a negative determination is made, the present routine is ended.

In step S109, the control unit 301 dispatches a vehicle to the user. For example, the control unit 301 transmits information for requesting the dispatch of a taxi together with information about the home address of the user to a server that manages taxis. In addition, in cases where the control unit 301 manages taxis, it selects an empty or available taxi closest to the user's home, and transmits instructions to head to the user's home. Also, in cases where the server 30 manages an autonomous driving vehicle, it transmits a route to the user's home to the autonomous driving vehicle, and further transmits to the autonomous driving vehicle a command to pick up the user at the user's home.

In step S110, the control unit 301 transmits an inquiry to the user terminal 20. This inquiry is to ask the user to confirm the action data that serves as a basis of the vehicle dispatch. The control unit 301 transmits the inquiry so that the screen illustrated in FIG. 5 is displayed on the output unit 25 of the user terminal 20. In addition, if necessary, information for prompting the user to change the information is also transmitted. Then, in step S111, the control unit 301 receives a response from the user. The control unit 301 receives, for example, the response corresponding to the screen illustrated in FIG. 6. In other words, the response is received with the check box corresponding to “PC OFF” unchecked. Here, note that if no response is received from the user terminal 20 after waiting for a predetermined period of time, the control unit 301 may treat it as if there was no change in the information sent from the user terminal 20.

In step S112, the control unit 301 updates the action information DB 311. Specifically, the control unit 301 updates the action information DB 311 according to the response received from the user terminal 20 in step S111. For example, in cases where the information transmitted in step S110 includes the information illustrated in FIG. 5 and the information received in step S111 includes the information illustrated in FIG. 6, the vehicle dispatch necessity corresponding to the A001 of the sign ID in FIG. 4 is changed from “YES” to “NO”, and the vehicle dispatch level is changed from “immediate dispatch” to blank. Further, the vehicle dispatch level corresponding to the A003 of the sign ID is changed from “2” to “immediate dispatch”.

Here, note that in the above example, when the user removes the check from the check box corresponding to “PC OFF” in his or her response, this may be stored in the auxiliary storage unit 33. Here, in cases where a combination of actions corresponding to “tooth brushing”, “closet opening and/or closing”, and “PC OFF” is detected as a combination of actions on and after the next time, this combination of actions corresponds to the A003 of the sign ID, and thus a vehicle is immediately dispatched to the user. For example, even in the case where there is also an action equivalent to “PC OFF” at this time, since a combination of actions corresponding to “tooth brushing” and “closet opening and/or closing” has been detected, it is determined that the action corresponds to the A003 instead of A001 of the sign ID, and vehicle dispatch is performed.

Then, for example, when transmitting an inquiry to the user terminal 20 in the subsequent step S111, the inquiry is transmitted in a state in which the check box corresponding to “PC OFF” is removed or unchecked. That is, the image illustrated in FIG. 6 may be displayed on the output unit 25 of the user terminal 20 so as to include the option “PC OFF”. By outputting the inquiry to the user terminal 20 in the state where the check box is unchecked in this way, the user can check the check box corresponding to “PC OFF” at a later time. In this way, it is possible to deal with a case where the action of the user before going out changes, a case where the user notices that “PC OFF” is related to going out, or the like. Here, since there are a plurality of actions of the user, it is difficult to display all of them on the output unit 25 of the user terminal 20 so that the user can select them. On the other hand, an action that has actually been detected before, such as “PC OFF”, can be displayed on the output unit 25 of the user terminal 20. Then, by displaying previous actions on the user terminal 20, it becomes easy for the user to add an action related to going out. Thus, it is possible to improve the convenience of the user.

On the other hand, when a negative determination is made in step S104, the control unit 301 executes confirmation processing in step S120. The confirmation processing is to confirm whether or not action data is related to a sign of movement of the user.

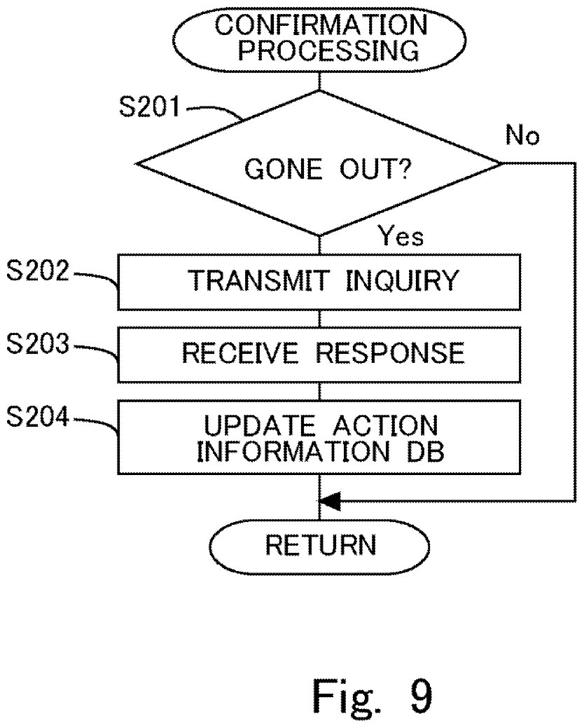

FIG. 9 is a flowchart of the confirmation processing. The confirmation processing is executed by the control unit 301 in step S120. In step S201, the control unit 301 determines whether or not the user has gone out. In this step S120, it is determined whether or not the user has gone out, even though there was no sign of movement. For example, the control unit 301 determines that the user has gone out, in cases where the user requests vehicle dispatch, or in cases where the position of the user terminal 20 detected by the position information sensor 27 is away from home. When an affirmative determination is made in step S201, the processing proceeds to step S202, whereas when a negative determination is made, the present routine is ended, and the processing of step S120 is also ended, whereby the routine illustrated in FIG. 8 is ended.

In step S202, the control unit 301 transmits an inquiry to the user terminal 20. This inquiry is to ask the user to confirm whether or not it is acceptable to dispatch a vehicle in response to the action data extracted in step S102 from this point on. In other words, since the combination of actions before going out is not stored in the behavior information DB 311, the control unit 301 confirms with the user whether or not the combination of actions can be entered into the action information DB 311. For example, in cases where the user goes out after smoking a cigarette, it is inquired whether the act of smoking a cigarette may be associated as a sign of movement.

The control unit 301 transmits an inquiry so that an image similar to that of FIG. 5, but with a check box displayed corresponding to the action data extracted in step S102, is displayed on the output unit 25 of the user terminal 20. At this time, for example, a check box corresponding to “smoking” is provided. In an initial state, a check is entered in this check box. Then, in step S203, the control unit 301 receives a response. This response includes, for example, an image similar to that in FIG. 6. For example, in cases where a check has been entered in the check box corresponding to “smoking”, it is determined that the act of smoking a cigarette is related to a sign of movement. In this case, in step S204, the control unit 301 enters YES into the vehicle dispatch necessity field of the A004 of the sign ID in FIG. 4. On the other hand, in cases where the check has been removed, the act of smoking a cigarette is unrelated to a sign of movement. Accordingly, NO is entered into the vehicle dispatch necessity field of the A004 of the sign ID in FIG. 4. Here, note that in cases where a response is not received from the user terminal 20 even after waiting for a predetermined period of time, the control unit 301 may not enter anything into the dispatch necessity field so that it can make an inquiry again.

In this way, vehicle dispatch is performed in response to new action data. Here, in order to learn the relationship (or association) between combinations of actions and signs of movement, for example, vehicle dispatch in response to the same action data needs to be performed a predetermined number of times or more. The predetermined number of times is three in the above example. The more this predetermined number of times is set, the higher the accuracy of the association becomes. However, the more the predetermined number of times, the more time is required for learning. On the other hand, the learning time can be shortened because it is no longer necessary to learn the relationship (or association) between combinations of actions and signs of movement based on user responses.

As described above, according to the present embodiment, it is possible to determine a sign of movement with higher accuracy in a system that determines whether or not a user has a sign of movement on the basis of an action(s) of the user and performs vehicle dispatch when the user has the sign of movement. That is, by allowing the user to select a combination of his or her actions that is related to a sign of movement, it is possible to associate the combination of actions of the user with the sign of movement with higher accuracy. As a result, the convenience of the user can be improved. Also, the learning time can be shortened by allowing the user to select.

In addition, by making an inquiry in step S110, it is possible to increase the accuracy of determination of a sign of movement. For example, if the user does not plan to go out, but the server 30 dispatches a vehicle and the user gets into that vehicle, the server 30 cannot recognize that the vehicle was dispatched by mistake. On the other hand, by making an inquiry to the user, it is possible to confirm whether or not the vehicle dispatch was appropriate.

Moreover, the user himself or herself can adjust the combination of user's actions related to the sign of movement, which can further improve the accuracy of the sign of movement. Also, even in cases where the relationship (or association) between the previous actions of the user and the sign of movement becomes low due to a change in the life of the user or the like, it is possible to quickly learn a new relationship between the actions of the user and the sign of movement by inquiring the user. In addition, by making an inquiry in step S110, the user can know a combination of actions that is a sign of movement.

Further, even in cases where a vehicle is dispatched when the user does not plan to go out and the user does not get on the vehicle, the actions of the user and the sign of movement can be appropriately associated with each other by inquiring the user in the step S110. Furthermore, in cases where the user does not plan to go out and no vehicle is dispatched, the association between the actions of the user and the sign of movement is not made, which prevents a vehicle from being dispatched by mistake in the future.

### OTHER EMBODIMENTS

The above-described embodiment is merely an example, and the present disclosure can be implemented with appropriate modifications without departing from the spirit thereof.

The processing and/or means (devices, units, etc.) described in the present disclosure can be freely combined and implemented as long as no technical contradiction occurs.

The processing described as being performed by one device or unit may be shared and performed by a plurality of devices or units. Alternatively, the processing described as being performed by different devices or units may be performed by one device or unit. In a computer system, a hardware configuration (server configuration) for realizing each function thereof can be changed in a flexible manner.

The above-described embodiment can also be applied when the information processing apparatus performs machine learning. That is, when a vehicle is dispatched to a user based on a result of machine learning, an action(s) serving as a basis for dispatching the vehicle to the user may be indicated.

The present disclosure can also be realized by supplying to a computer a computer program in which the functions described in the above-described embodiment are implemented, and reading out and executing the program by means of one or more processors included in the computer. Such a computer program may be provided to the computer by a non-transitory computer readable storage medium that can be connected to a system bus of the computer, or may be provided to the computer via a network. The non-transitory computer readable storage medium includes, for example, any type of disk such as a magnetic disk (e.g., a floppy (registered trademark) disk, a hard disk drive (HDD), etc.), an optical disk (e.g., a CD-ROM, a DVD disk, a Blu-ray disk, etc.) or the like, a read-only memory (ROM), a random-access memory (RAM), an EPROM, an EEPROM, a magnetic card, a flash memory, an optical card, or any type of medium suitable for storing electronic commands or instructions.

What is claimed is:

1. An information processing apparatus including a controller configured to perform:
detecting combinations of actions of a user before the user moves;
allowing the user to select a first combination of actions related to a movement of the user from among the combinations of actions detected; and
providing a service to the user when the first combination of actions is detected.

2. The information processing apparatus according to claim 1, wherein
when allowing the user to select the first combination of actions, the controller displays the detected combinations of actions on a terminal of the user and allows the user to select the first combination of actions from among them.

3. The information processing apparatus according to claim 1, wherein
when allowing the user to select the first combination of actions, the controller also allows the user to select whether or not provision of the service is necessary when the first combination of actions is detected.

4. The information processing apparatus according to claim 1, wherein
when allowing the user to select the first combination of actions, the controller also allows the user to select whether or not the service is provided without confirmation when the first combination of actions is detected.

5. The information processing apparatus according to claim 1, wherein
the controller stores an action that is not included in the first combination of actions among the detected combinations of actions.

6. The information processing apparatus according to claim 1, further comprising:
a memory configured to store the combination of the first actions.

7. The information processing apparatus according to claim 1, wherein
after the first combination of actions has been detected and the service has been provided to the user, the controller transmits information about a change in the first combination of actions to the terminal of the user.

8. An information processing method for causing a computer to perform:
detecting combinations of actions of a user before the user moves;
allowing the user to select a first combination of actions related to a movement of the user from among the combinations of actions detected; and
providing a service to the user when the first combination of actions is detected.

9. The information processing method according to claim 8, wherein
when allowing the user to select the first combination of actions, the computer displays the detected combinations of actions on a terminal of the user and allows the user to select the first combination of actions from among them.

10. The information processing method according to claim 8, wherein
when allowing the user to select the first combination of actions, the computer also allows the user to select whether or not provision of the service is necessary when the first combination of actions is detected.

11. The information processing method according to claim 8, wherein
when allowing the user to select the first combination of actions, the computer also allows the user to select whether or not the service is provided without confirmation when the first combination of actions is detected.

12. The information processing method according to claim 8, wherein
the computer stores an action that is not included in the first combination of actions among the detected combinations of actions.

13. The information processing method according to claim 8, wherein
the computer stores the first combination of the actions in a memory.

14. The information processing method according to claim 8, wherein
after the first combination of actions has been detected and the service has been provided to the user, the computer transmits information about a change in the first combination of actions to the terminal of the user.

15. A system comprising:
a sensor configured to detect actions of a user;
a terminal of the user; and
a server having a controller;
wherein the controller performs:
detecting, based on the actions of the user detected by the sensor, combinations of actions of the user before the user moves;
transmitting, to the terminal of the user, information for allowing the user to select a first combination of actions related to a movement of the user from among the combinations of actions detected;
receiving information about the first combination of actions from the terminal of the user; and
providing a service to the user when the first combination of actions is detected.

16. The system according to claim 15, wherein
when allowing the user to select the first combination of actions, the controller displays the detected combinations of actions on a terminal of the user and allows the user to select the first combination of actions from among them.

17. The system according to claim 15, wherein
when allowing the user to select the first combination of actions, the controller also allows the user to select whether or not provision of the service is necessary when the first combination of actions is detected.

18. The system according to claim 15, wherein
when allowing the user to select the first combination of actions, the controller also allows the user to select whether or not the service is provided without confirmation when the first combination of actions is detected.

19. The system according to claim 15, wherein
the controller stores an action that is not included in the first combination of actions among the detected combinations of actions.

20. The system according to claim 15, wherein
after the first combination of actions has been detected and the service has been provided to the user, the controller transmits information about a change in the first combination of actions to the terminal of the user.
